(19) United States
(12) Patent Application Publication
(10) Pub. No.: US 2026/0209069 A1
(43) Pub. Date: Jul. 23, 2026

(54) A CATHODE COMPOSITION

(71) Applicant: Dyson Technology Limited, Malmesbury, Wiltshire (GB)

(72) Inventors: Sujoy SAHA, Oxford (GB); Niccolo GUERRINI, Oxford (GB); Matthew Robert ROBERTS, Oxford (GB)

(21) Appl. No.: 19/140,789

(22) PCT Filed: Jan. 4, 2024
(86) PCT No.: PCT/IB2024/050072

§ 371 Date: Jun. 18, 2025

(30) Foreign Application Priority Data
Jan. 10, 2023 (GB) 2300340.3

(51) Int. Cl. C01G 49/00; H01M 4/02; H01M 4/485

(52) U.S. Cl. CPC C01G 49/0045; H01M 4/485; C01P 2002/72; C01P 2006/40; H01M 2004/028

(57) ABSTRACT

A cathode material for a battery, wherein the cathode material has an anti-fluorite crystal structure and belongs to a family represented by the formula Li₅Fe₍₁₋ₓ₎AlₓO₄, wherein x is greater than zero and less than or equal to one.

### TECHNICAL FIELD

The invention relates to a cathode material for a battery, and to a method of making a cathode for a battery.

### BACKGROUND

Modern society is defined by an ever-increasing proliferation of small-scale electrified devices, such as mobile phones, tablets and smartwatches and also the gradual electrification of larger machines, such as automobiles. Across all electrified devices, a common goal is to produce higher capacity rechargeable (secondary) batteries, for example to support greater processing power in a device or to increase the range of an electric vehicle. As secondary batteries become ever more crucial to the functioning of a multitude of everyday products, there is also an increased focus on sustainability. This takes many guises, ranging from looking to improve the electrochemical stability of batteries over numerous charging cycles to improve the lifetime of the battery to an assessment of the materials from which the batteries are made, with a view to using materials that are less energy intensive to extract from their ores, or are more abundant, or are less toxic to the environment.

Current high-performance secondary batteries are typically referred to in general as ‘lithium ion batteries’. The cathode materials used to make lithium ion batteries are generally lithiated transition metal oxide compounds such as NMC (LiNiₓMn_{y}Co_{z}O₂).

These are composed of metals such as cobalt and nickel, which are costly and are becoming scarce, especially in view of projected future battery demands. They are also toxic in nature and pose environmental hazard risks.

There is a therefore a desire to look to cheaper and less toxic metals for alternative cathode materials to provide a greener solution for future energy storage applications, that can match or exceed current performance. It is against this background that the invention is set.

### SUMMARY OF THE INVENTION

In a first aspect, the invention provides a cathode material for a battery. The cathode material has the anti-fluorite crystal structure and belongs to the family represented by the formula Li₅Fe₍₁₋ₓ₎AlₓO₄, wherein x is greater than zero and less than or equal to one.

The cathode material has a substituted Li₂O-based antifluorite structure, with iron and aluminium ions taking the place of lithium ions within the structure to increase the structural stability of the cathode material through charging cycles. The addition of iron and aluminium ensures a high specific capacity as simultaneous anionic and cationic redox can occur through redox of the oxygen species, as well as the iron and aluminium.

Finally, the high abundance, low cost and non-toxicity of both iron and aluminium makes the cathode composition significantly more environmentally-friendly than existing cathode materials that often contain cobalt and/or nickel.

The value of x for the cathode material may be less than or equal to 0.5, and preferably may be greater than or equal to 0.1 and less than or equal to 0.25. These values of x provide the best compromise between a number of factors important for good, practical electrochemical performance, such as specific capacity, electrical conductivity and integrity of the crystal structure under repeated cycles of charging and discharging.

The cathode material may take the β-polymorph structure, which is an orthorhombic structure in the Pbca space group.

In a second aspect, the invention provides a method of making a cathode for a battery. The method comprises: mixing Li₂O, LiFeO₂ and Al₂O₃ powders in a stoichiometric ratio; ball milling the powders; heating the powders to consolidate them into a cathode material; and allowing the cathode material to cool to room temperature. The stoichiometric ratio of the powders is such that the cathode material has the formula Li₅Fe₍₁₋ₓ₎AlₓO₄, wherein x is greater than zero and less than or equal to one.

The method may comprise heating the powders to between 650° C. and 750° C., preferably to 700° C. The method may comprise heating the powders to between 850° C. and 1000° C. The method may comprise heating the powders for at least 15 hours. The cathode material may be cooled to room temperature at a rate of at least 5° C. per minute. Cooling the cathode material in this way, in combination with heating the powders to between 850° C. and 1000° C. and the presence of aluminium in the crystal structure enables the stabilisation of the β-polymorph of Li₅Fe₍₁₋ₓ₎AlₓO₄.

The value of x may be less than or equal to 0.5 and preferably may be greater than or equal to 0.1 and less than or equal to 0.25.

In a third aspect, the invention provides a cathode comprising the cathode material discussed above. In a fourth aspect, the invention provides an electrochemical cell comprising such a cathode, an electrolyte and an anode. The cell may be a secondary battery.

### BRIEF DESCRIPTION OF THE FIGURES

The invention will now be described with reference to the following drawings, in which: FIG. 1 shows a super-cell of Li₂O, which takes the anti-fluorite crystal structure and a unit cell of α-Li₅Fe_{0.5}Al_{0.5}O₄;

FIGS. 2a and 2b show X-ray diffraction patterns for members of the family of materials represented by the general formula Li₅Fe₍₁₋ₓ₎AlₓO₄ using Cu Ka radiation;

FIG. 3 shows a Rietveld refinement of the X-ray diffraction pattern of a synthesized phase of α-Li₅Fe_{0.5}Al_{0.5}O₄;

FIG. 4a shows a charge-discharge curve for α-Li₅Fe_{0.8}Al_{0.2}O₄ in the first cycle, with the voltage limited to 1.5 V during discharge;

FIG. 4b shows charge-discharge curves for α-Li₅Fe_{0.8}Al_{0.2}O₄ in the first and twentieth cycles, with the voltage limited to 3.6 V when charging and 1.5 V during discharge;

FIG. 5a shows a charge-discharge curve for β-Li₅Fe_{0.75}Al_{0.25}O₄ in the first cycle, with the discharge limited to 1 V during discharge; and

FIG. 5b shows a charge-discharge curve for β-Li₅Fe_{0.7}Al_{0.25}O₄ in the first, second, third and twentieth cycles, with the voltage limited to 3.6 V when charging and 1.5 V during discharge.

### DETAILED DESCRIPTION

Research into promising lithium-rich cathode compositions is widespread. For example, KR 20130079109 A discloses a number of possible materials for a cathode for a secondary battery. The present invention relates to a cathode material with the general formula Li₅Fe₍₁₋ₓ₎AlₓO₄ having the anti-fluorite crystal structure, wherein the value of x is greater than zero and less than or equal to one.

As is well-known, batteries generate electricity through the use of chemical reactions occurring at the electrodes. In secondary batteries, the reactions are reversible redox reactions. During discharge of the battery a species is oxidised at the anode, which generates lithium ions (Li⁺) and electrons (e⁻), with another species, reduced at the cathode in incorporating the generated lithium ions into the cathode material. During charging of the battery, the two reactions at each electrode are reversed. In an NMC cathode, for example, the species reduced during discharge are nickel, manganese and cobalt, which are transition metals. The specific capacity of current lithium ion batteries is limited by the number of lithium ions available to reversibly intercalate into the structure of the cathode and by the high atomic weight of the transition metal cations, since the specific capacity of a battery is normalised by mass.

A recent development in cathode materials for secondary batteries has been the discovery of cathodic oxygen redox. This differs from the current redox of transition metals at the cathode as it relies on anionic redox of oxygen ligands at the cathode, as opposed to cationic redox when transition metals form the redox centre (oxygen-based ions are typically negatively charged, while transition metal ions are positively charged).

Of materials proposed to take advantage of cathodic oxygen redox, Li₂O has highest possible theoretical specific capacity as it contains no heavy transition metals and therefore relies only on oxygen redox. The redox reaction is given by:

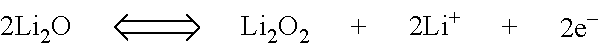

The potential of this reaction is approximately 3.0 V against the Li⁺/Li redox occurring at the anode. However, despite the high theoretical specific capacity of Li₂O-based cathodes, both Li₂O and Li₂O₂ show low electrochemical activities and poor electrical conductivity and so needs a catalyst. Another issue is that Li₂O-based cathodes release oxygen gas (O₂) due to metastability of the delithiated Li₂O and so their electrochemical performance is further adversely impacted by their structural instability.

One way of addressing the poor performance of Li₂O-based cathodes is to improve the ionic and electrical conductivities of the cathode. One promising way of achieving this has been through the partial substitution of lithium with transition metals to create lithium-rich defect anti-fluorite compounds. One such compound is Li₅FeO₄. If four unit cells of Li₂O, effectively a single cell of Li₈O₄ are considered, replacing three Li⁺ ions with one Fe³⁺ ion and two lithium vacancies creates Li₅FeO₄. The left hand side of FIG. 1 shows a super cell of Li₂O, with the lithium ions labelled 10 and the oxygen ions labelled 20, while the right hand side shows the same cell having had the lithium ions substituted as described above, with the potential iron ions/vacancy sites collectively labelled 30.

Li₅FeO₄ offers an enhanced ionic and electrical conductivity compared to Li₂O, due to the vacancies present in the structure. The specific capacity of Li₅FeO₄ has been theorised to be at least 700 mAh/g as a result of the high lithium content, as well as the effect of the oxygen redox in addition to the redox of the transition metal Fe³⁺ ion. This simultaneous cationic and anionic redox can occur as the redox potential of the O²⁻/O⁻ reaction is similar to that of the Fe³⁺/Fe⁴⁺ reaction. In addition to the high theoretical specific capacity, Li₅FeO₄ cathodes use cheaper, more abundant materials than current alternatives and are cobalt and nickel free, so are more environmentally friendly.

However, Li₅FeO₄ cathodes still face numerous challenge arising from poor electrochemical performance, arising mainly from structural instability and loss of oxygen from the lattice under repeated cycling. One reason for this is the Fe³⁺/Fe⁴⁺ redox, which leads to gradual amorphization of the crystal structure of Li₅FeO₄. This is because repeated intercalation and deintercalation of the lithium ions in charge and discharge cycles of the cathode requires the iron ions to repeatedly change from the +3 oxidation state occupied by Fe³⁺ ions to the +4 oxidation state occupied by Fe⁴⁺ ions. However, this causes the co-ordination around the iron ions changes from a tetrahedral co-ordination around the Fe³⁺ ions to an octahedral co-ordination around Fe⁴⁺ ions. As the charge and discharge cycles are repeated, incomplete reconstruction of the oxygen co-ordination around each iron ion in each redox cycle eventually leads to amorphization of the crystal structure and subsequent loss of oxygen from the lattice.

The inventors have found that these issues can be at least partially mitigated by the partial substitution of iron by other trivalent ions, such as aluminium in Li₅FeO₄. In the case of partial substitution by aluminium, the resulting family of materials has the general formula Li₅Fe₍₁₋ₓ₎AlₓO₄. Depending on the value of x, a different proportion of the iron ions are replaced by aluminium ions. The unit cell on the right hand side of FIG. 1 shows the iron ion/vacancy sites 30 with a half-and-half shading pattern to demonstrate that aluminium ions have replaced half of the iron ions. That unit cell therefore represents Li₅Fe_{0.5}Al_{0.5}O₄ (i.e., x=0.5).

The Li₅Fe₍₁₋ₓ₎AlₓO₄ family of materials enjoys largely the same benefits of Li₅FeO₄ cathodes in that the high lithium content and simultaneous cationic and anionic redox ensures a high specific capacity, while using abundant, cheap, non-toxic materials. However, the addition of aluminium helps keep the crystal structure intact as it is a redox-inactive element and so does not undergo any change in oxidation state. The addition of aluminium also increases the theoretical specific capacity because of its lower weight, however, at the same time it decreases the number of active species to take part in the redox processes, having substituted into the structure in place of redox-active iron, and also decreases the electrical conductivity of the crystal structure. In particular, the reduced number of redox-active species eventually reduces the practical specific capacity of the cathode material as the value of x increases, as lithium intercalation and deintercalation requires a redox process to occur. Increasing the value of x too high therefore effectively reduces the number of lithium ions that can intercalate and deintercalate into and from the cathode.

Therefore, there is a balance to be struck between a number of factors (including theoretical and practical specific capacity, electrical conductivity and number of redox-active species) in order to achieve optimal performance with reasonable and practical levels of structural integrity.

The inventors have also found that the Li₅Fe₍₁₋ₓ₎AlₓO₄ family of materials have two polymorphs, denoted here as α-Li₅Fe₍₁₋ₓ₎AlₓO₄ and β-Li₅Fe(₁X)AlₓO₄, which are in the orthorhombic Pmmn and Pbca space groups, respectively. In general, the α-polymorph is the low-temperature polymorph, whereas the β-polymorph is the high-temperature polymorph. However, the high-temperature β-Li₅Fe₍₁₋ₓ₎AlₓO₄ polymorphs (except for Li₅FeO₄, x=0) can be successfully stabilised at room temperature, as will be described below. In other words, the presence of aluminium helps to stabilise the β-polymorph at room temperature. Both the α-polymorph and the β-polymorph take the anti-fluorite crystal structure, however in the β-polymorph, there is a greater degree of symmetry in the crystal structure, possibly as a result of improved lithium distribution.

A range of materials within this family, with different values of x have been synthesized. The cathode materials can be synthesised by typical powder processing routes. In one method, precursor powders are initially taken in stoichiometric amounts in a ball-mill jar and then ball-milled and eventually heated to react and obtain the final powder of Li₅Fe₍₁₋ₓ₎AlₓO₄ compositions. The ball-milling may occur at 200 rpm using stainless steel balls in stainless steel jars for four periods of 30 minutes, with a 15 minute break in between each period to allow the powder to cool down. It will be appreciated that any ball-milling process, or similar process, may be used in order to prepare a suitably fine powder for consolidation.

For the manufacture of Li₅Fe₍₁₋ₓ₎AlₓO₄ compositions, a mixture of Li₂O, LiFeO₂ and Al₂O₃ powders are used, with the exact stoichiometric ratio of the three powders depending on the value of x of the final composition. To synthesise the α-polymorphs, the ball-milled precursor powder mixture can be heated to between 650° C. and 750° C., preferably to 700° C. for at least 10 hours, preferably 15 hours, while the β-polymorphs are synthesised by heating either the ball-milled precursor powder mixture or the synthesised a-polymorph powders to between 850° C. and 1000° C. for at least 10 hours, preferably 15 hours, followed by quenching or rapid cooling at a cooling rate of at least 5° C. per minute until the sample reaches room temperature. This cooling rate, in combination with the presence of the substituted aluminium in the crystal structure enables the room temperature stabilisation of the β-polymorphs. Naturally, however, it is also necessary to heat the powder to a high enough temperature for the β-polymorph to form in the first place.

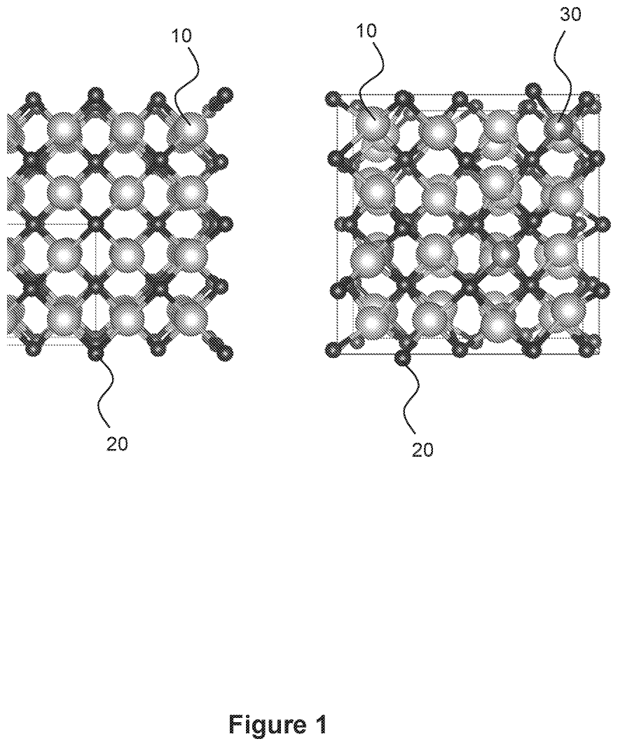

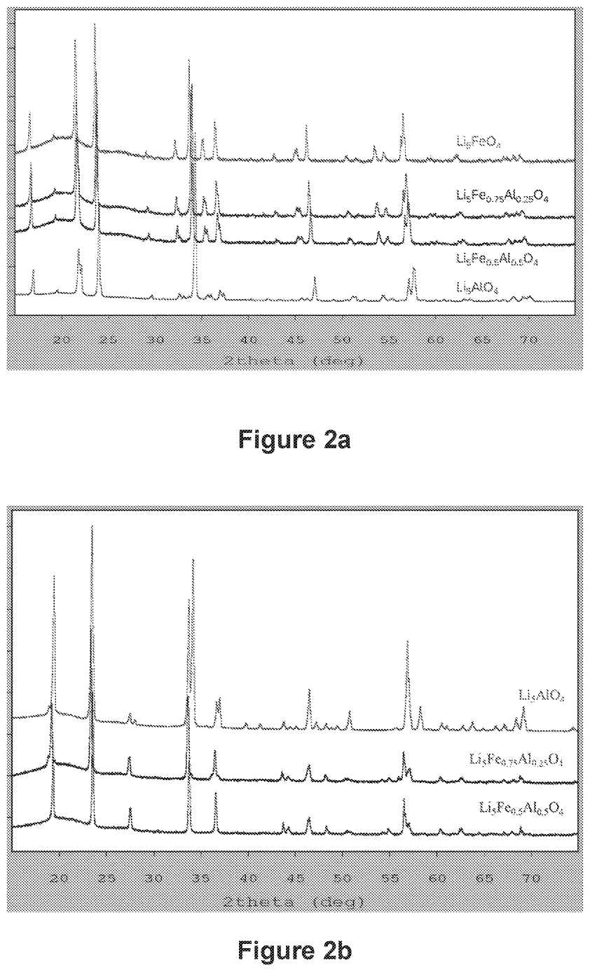

FIG. 2a shows X-ray diffraction (XRD) patterns for Li₅FeO₄, α-Li₅Fe_{0.75}Al_{0.25}O₄, α-Li₅Fe_{0.5}Al_{0.5}O₄ and α-Li₅AlO₄ (i.e., values of x of 0, 0.25, 0.5 and 1). FIG. 2b, on the other hand, shows XRD patterns for, β-Li₅Fe_{0.7}Al_{0.25}O₄, β-Li₅Fe_{0.5}Al_{0.50}O₄ and β-Li₅AlO₄ (i.e., values of x of 0.25, 0.5 and 1).

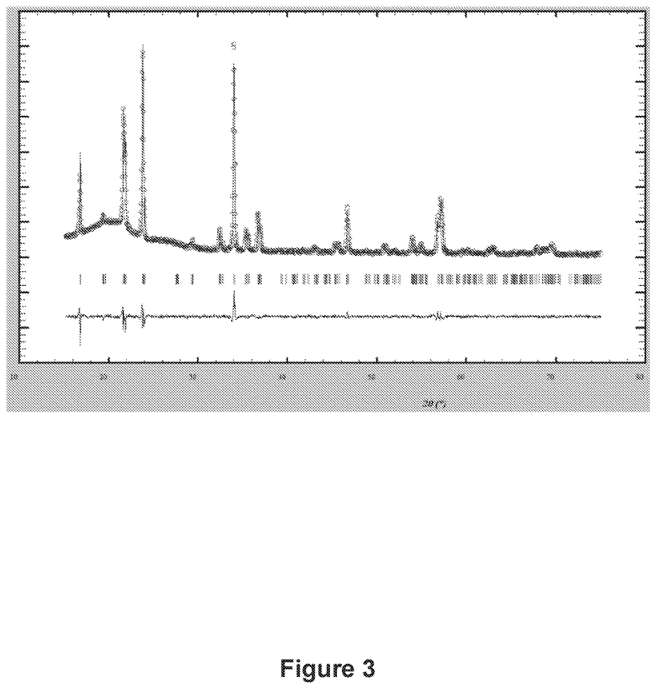

The purity of these synthesised phases was assessed by carrying out Rietveld refinements on the XRD patterns of the as-synthesized samples. A representative resulting analysis is shown in FIG. 3, for the α-Li₅Fe_{0.5}Al_{0.5}O₄ (x=0.5) sample, in which a suitable crystal structure was determined and refined against the XRD pattern shown in FIG. 2. A satisfactory fit is seen between the refinement and the measured XRD pattern, and all the peaks in the XRD pattern could be indexed, indicating that the synthesised phase is pure.

Of the substituted cathode materials investigated by the inventors, strongest electrochemical performance was observed with values of x greater than zero, but below 0.5, with especially good performance seen with values of x between 0.1 and 0.25. At values of x above 0.5, the compositions start becoming inactive, as the aluminium is redox-inactive and further decreases the electrical conductivity of the compositions.

Values of x between 0.1 and 0.25, such as x=0.1 and x=0.2 show the best compromise between improving the structural stability of the cathode composition under cycling and maintaining acceptable electrochemical performance.

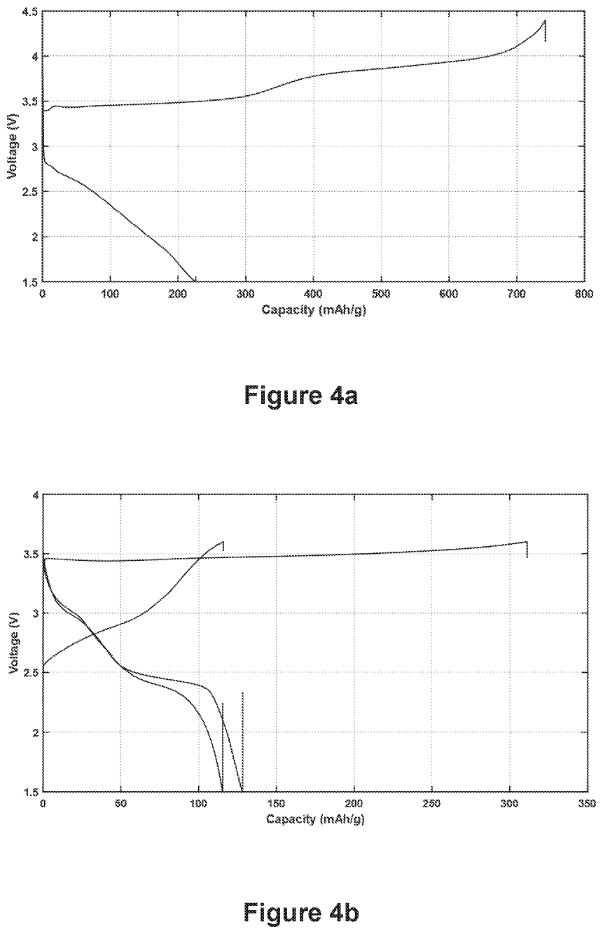

The electrochemical performance of α-Li₅Fe_{0.8}Al_{0.2}O₄ (x=0.2) was investigated and is shown in FIGS. 4a and 4b. FIG. 4a shows that a specific capacity of over 700 mAh/g is achieved in the first charge, although only approximately 220 mAh/g could be extracted in the first discharge when the discharge was limited to 1.5 V. FIG. 4b shows the performance of α-Li₅Fe_{0.8}Al_{0.2}O₄ in the first and twentieth cycles and shows that the specific capacity stabilises at between 100 and 150 mAh/g upon cycling, with the voltage limited to 3.6 V when charging and 1.5 V during discharge.

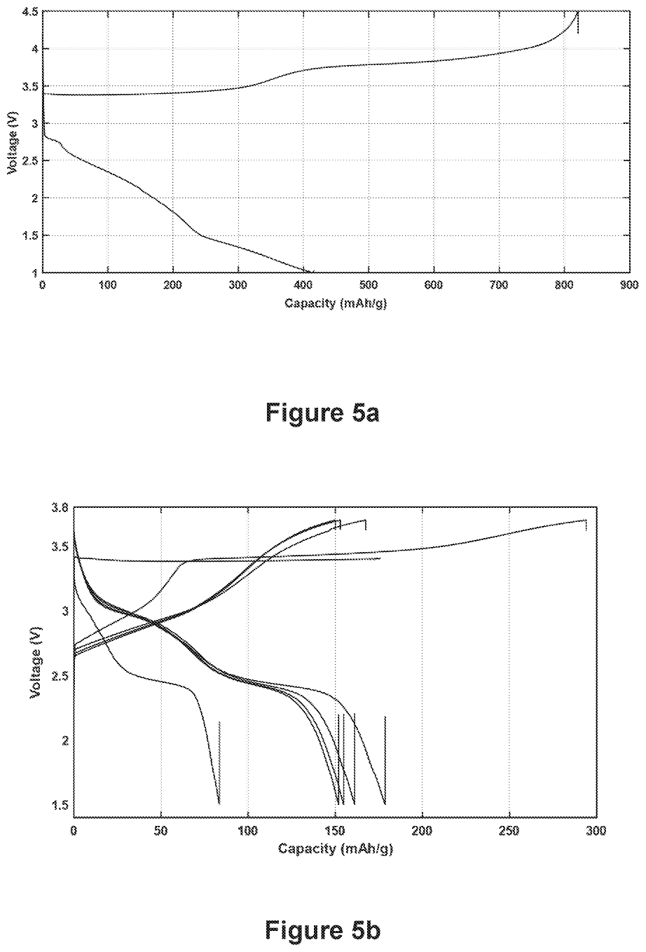

The electrochemical performance of β-Li₅Fe_{0.75}Al_{0.25}O₄ (x=0.25) was also investigated and is shown in FIGS. 5a and 5b. As can be seen in FIG. 5a, a specific capacity of over 800 mAh/g is achieved in the first charge. Only approximately 220 mAh/g could be extracted in the first discharge, if the discharge was limited to 1.5 V, although this increases to approximately 410 mAh/g if the discharge is instead limited to 1 V. FIG. 5b shows the performance of β-Li₅Fe_{0.7}Al_{0.25}O₄ in the first, second, third and twentieth cycles. While only approximately 80 mAh/g is extracted in the first discharge during this test, subsequent cycles show that the specific capacity stabilises at approximately 150 mAh/g upon cycling, with the voltage limited to 3.6 V when charging and 1.5 V during discharge.

It will be appreciated that various modifications may be made to the invention as described herein without departing for the scope of protection defined by the appended claims.

1. A cathode material for a battery, wherein the cathode material has an anti-fluorite crystal structure that occupies an orthorhombic Pbca space group and belongs to a family represented by the formula Li₅Fe₍₁₋ₓ₎AlₓO₄, wherein x is greater than zero and less than or equal to one.

2. The cathode material of claim 1, wherein x is less than or equal to 0.5.

3. The cathode material of claim 2, wherein x is greater than or equal to 0.1 and less than or equal to 0.25.

4. A method of making the cathode material of claim 1, the method comprising:
mixing Li₂O, LiFeO₂ and Al₂O₃ powders in a stoichiometric ratio;
ball milling the mixed powders;
heating the ball milled powders to consolidate them into a cathode material; and
rapidly cooling the cathode material to room temperature at a rate of at least 5° C. per minute.

5. The method of claim 4, comprising heating the ball milled powders to between 650° C. and 750° C.

6. The method of claim 5, comprising heating the ball milled powders to 700° C.

7. The method of claim 4, comprising heating the ball milled powders to between 850° C. and 1000° C.

8. The method of claim 4, comprising heating the ball milled powders for at least 15 hours.

9. The method of claim 4, wherein x is less than or equal to 0.5.

10. The method of claim 9, wherein x is greater than or equal to 0.1 and less than or equal to 0.25.

11. A cathode comprising the cathode material according to claim 1.

12. An electrochemical cell comprising a cathode according to claim 11, an electrolyte and an anode.

13. The electrochemical cell of claim 12, wherein the electrochemical cell is a secondary battery.
